(19) United States
(12) Patent Application Publication
(10) Pub. No.: US 2012/0279128 A1
(43) Pub. Date: Nov. 8, 2012

(54) PULSE DETONATION COAL GASIFICATION SYSTEM

(75) Inventors: Tian Xuan Zhang, Overland Park, KS (US); David Michael Chapin, Overland Park, KS (US); Robert Warren Taylor, Ponte Vedra Beach, FL (US)

(73) Assignee: BHA Group, Inc., Kansas City, MO (US)

(21) Appl. No.: 13/099,646

(22) Filed: May 3, 2011

(51) Int. Cl. B01J 7/00; C10L 3/00

(52) U.S. Cl. 48/61; 48/210

(57) ABSTRACT

A pulse detonation device is provided for delivering a shock wave into a gasification device to promote a localized coal gasification reaction in the gasification device. The pulse detonation device includes a fuel inlet for receiving fuel, an air inlet for receiving air, a pulse detonation chamber wherein the fuel and air are configured to mix, and an ignition device for igniting the mixture of fuel and air. The ignition of the mixture of fuel and air creates a shock wave in the pulse detonation chamber. Further, the pulse detonation chamber is attached to a gasification chamber and is configured to extend into a coal feed tube that extends into the gasification chamber, with the shock wave configured to exit the pulse detonation chamber and interact with coal in the coal feed tube.

### BACKGROUND OF THE INVENTION

1. Field of the Invention

The invention relates to gasification devices for gasifying coal and, more particularly, to a pulse detonation device that delivers a high temperature and pressure pulse wave to gasify coal within a coal feed tube.

2. Discussion of Prior Art

A gasification process can be used to convert a carbon based material, such as coal, into a gas mixture that can be used as a fuel. The gasification process can occur in a gasification device. A gasification device may include a moving-bed gasifier, a fluidized-bed gasifier, an entrained-flow gasifier, a slagging gasifier, etc. A combination of high temperature, pressure, and a controlled amount of oxygen and/or steam can be used to react with the coal to produce the desired gas mixture. However, there may be a limited amount of oxygen available in the gasification chamber to react with the coal during the gasification phase. Further, a sufficiently high temperature and pressure may be difficult to achieve to accomplish the gasification reaction. Accordingly, it would be useful to provide a method and/or device to provide a localized high temperature and pressure to the coal such that the coal can be gasified.

### BRIEF DESCRIPTION OF THE INVENTION

The following summary presents a simplified summary in order to provide a basic understanding of some aspects of the systems and/or methods discussed herein. This Summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides a pulse detonation device providing a shock wave for promoting a coal gasification reaction in a gasification device, the pulse detonation device including a fuel inlet configured to receive fuel, an air inlet configured to receive air, a pulse detonation chamber wherein the fuel and air are configured to mix, and an ignition device configured to ignite the mixture of fuel and air, wherein the ignition of the mixture of fuel and air creates a shock wave in the pulse detonation chamber. Further, the pulse detonation chamber is attached to a gasification chamber and is configured to extend into the gasification chamber, further wherein the shock wave is configured to exit the pulse detonation chamber and interact with coal in the gasification chamber.

In accordance with another aspect, the present invention provides a gasification system for promoting a coal gasification reaction in a gasification device, the gasification system including a gasification chamber, at least one coal feed tube including an inlet configured to receive coal, wherein the at least one coal feed tube extends from an exterior of the gasification chamber to an interior of the gasification chamber, and at least one pulse detonation device. The at least one pulse detonation device includes a pulse detonation chamber in which fuel and air are configured to mix and ignite. The ignition of the mixture of fuel and air is configured to produce a shock wave exiting from an end of the pulse detonation chamber. Further, the pulse detonation chamber of the at least one pulse detonation device is configured to extend from the exterior of the gasification chamber, through a wall of the gasification chamber, and into an interior of the at least one coal feed tube, further wherein the shock wave is configured to exit the pulse detonation chamber and interact with coal in the at least one coal feed tube.

In accordance with another aspect, the present invention provides a method of providing a shock wave to increase gasification within a gasification device, the method includes providing a pulse detonation device having an open end. The method further includes attaching the pulse detonation device to the gasification chamber, wherein the open end of the pulse detonation device extends at least partially into the gasification chamber and mixing fuel and air in the pulse detonation device. The method further includes igniting the mixture of fuel and air in the pulse detonation device to create a shock wave, wherein the shock wave exits the open end of the pulse detonation device, enters the gasification chamber, and interacts with coal in the gasification chamber.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a sectional side view of an example gasification device with example pulse detonation devices shown;

FIG. 2 is a cutaway view of the example pulse detonation devices passing through a wall of the gasification device of FIG. 1;

FIG. 3 is a perspective view of an example pulse detonation device extending into the gasification device and into a feed tube; and

FIG. 4 is a top cutaway view of example pulse detonation devices passing through a wall of the gasification device.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

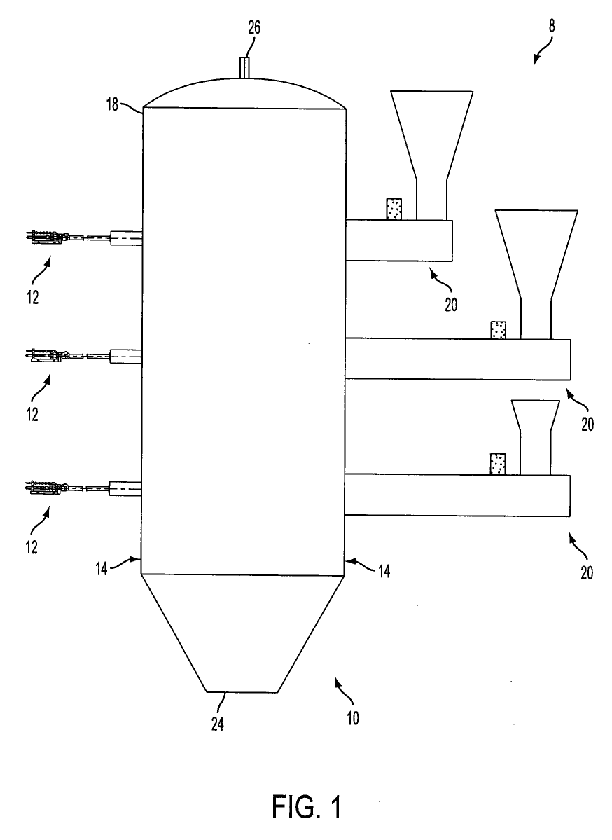

FIG. 1 illustrates a gasification system 8 for promoting a gasification reaction in a gasification device 10. The gasification system 8 can include one or more pulse detonation devices 12 in association with the gasification device 10. Within the shown example, three pulse detonation devices 12 are associated with the gasification device 10.

It is to be appreciated that the gasification device 10 is only generally/schematically shown in the figures, and may be varied in construction and function. For instance, the gasification device 10 may include a variety of gasification devices including, but not limited to, a moving-bed gasifier, a fluidized-bed gasifier, an entrained-flow gasifier, a slagging gasifier, etc. Similarly, the gasification device 10 can vary between a wide range of high-temperatures and high-pressures depending on the application. As such, the gasification device 10 need not be a specific limitation upon the present invention.

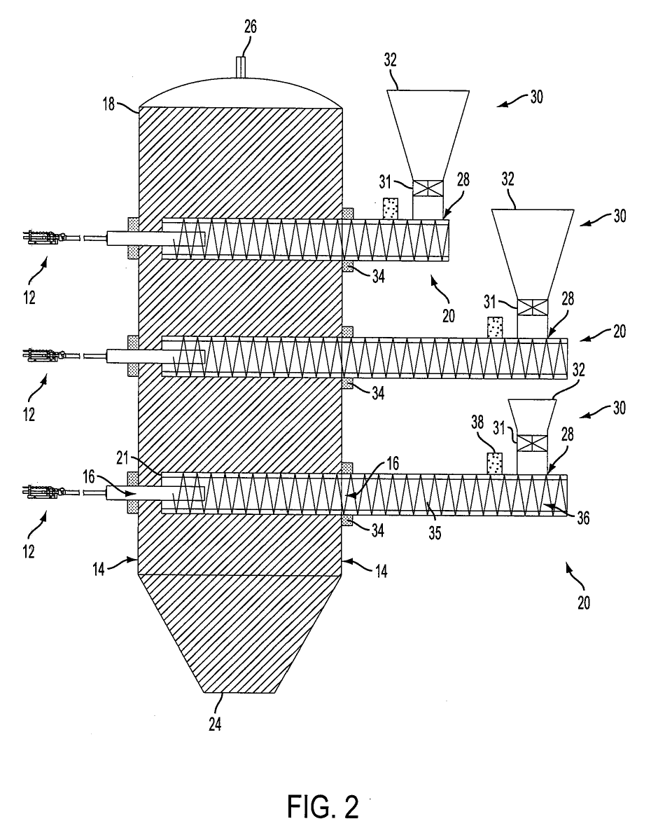

Referring still to FIG. 1, the gasification device 10 includes a gasification chamber 18. The gasification chamber 18 can be defined by a wall 14, and may include one or more holes 16 (shown in FIG. 2) extending through the wall 14. In the shown examples, there are six holes, however, it is to be understood, that more than six holes or as few as two holes may be provided. The holes 16 can provide an opening from an exterior of the gasification chamber 18 to an interior of the gasification chamber 18. Accordingly, a variety of devices, including the pulse detonation device 12 and a coal feed tube 20, can extend through the holes 16 to the interior of the gasification chamber 18.

The gasification device 10 can convert a carbon based material, such as coal, into a gas. The coal can be introduced into the gasification chamber 18. A combination of high temperature, pressure, and a controlled amount of oxygen and/or steam can react with the coal to produce a gas mixture and slag. In the present example, the gas mixture can include CO, CH₄, and H₂, however, other gas mixtures are contemplated. The gas mixture can later be used as a fuel. The gas mixture can exit the gasification chamber 18 through a gas outlet 26. The gas outlet 26 is disposed towards the top of the gasification chamber 18 in the shown example. However, it is to be understood, that the gas outlet 26 can be positioned at a variety of locations in the gasification chamber 18, depending on the specific gasification device and application. For instance, the gas outlet 26 can be positioned on the wall 14 towards the top of the gasification chamber 18, etc.

In addition to the gas mixture, slag is one of the byproducts of the gasification process and can be removed from the gasification chamber 18. Slag, and any other solid or liquid byproducts, may be removed from the gasification chamber 18 at a discharge outlet 24. Some or all of the byproducts from the gasification reaction, including slag, can fall to the bottom of the gasification chamber 18 and be removed through the discharge outlet 24. The discharge outlet 24 is shown to be disposed towards the bottom of the gasification chamber 18 in the shown example. However, similar to the gas outlet 26, the discharge outlet 24 is not limited to the bottom, and can be positioned anywhere in the gasification chamber 18, depending on the specific gasification device and application. For instance, the discharge outlet 24 can be positioned on the wall 14 towards the bottom of the gasification chamber 18, etc.

During the gasification reaction, coal can be burned to produce the desirable gas mixture. However, in certain instances, there may be a limited amount of oxygen available in the gasification chamber 18 to react with the coal during the gasification phase. Furthermore, a sufficiently high temperature and pressure may be difficult to achieve in the gasification chamber 18. Therefore, an example of the pulse detonation device 12 can be used to provide a localized high temperature and high pressure by delivering a shock wave into the gasification device 10. More specifically, the shock wave can be directed towards the location of the coal, such that the shock wave can react with the coal.

Referring now to FIG. 2, a cutaway view is shown of an example of the coal feed tube 20 in attachment with the wall 14 of the gasification chamber 18. The coal feed tube 20 can receive coal from the exterior of the gasification chamber 18 and deliver the coal, gas mixture, and slag to the interior of the gasification chamber 18. In the shown example, there are three coal feed tubes 20, however, any number of coal feed tubes can be provided. For instance, the gasification device 10 can include one or more coal feed tubes. Each coal feed tube 20 can be an elongated structure with a hollow center. Each coal feed tube 20 can be any length, and is not limited to the lengths in the shown example. For instance, each coal feed tube 20 can be shorter, as shown in the top coal feed tube, or can be longer, as shown in the middle and bottom coal feed tube. Moreover, each coal feed tube 20 can include a variety of shapes. For instance, each coal feed tube 20 in the shown example can be substantially circular in cross-section. However, in other examples, each coal feed tube 20 can have a cross-sectional shape that is oval, rectangular, or the like. It is to be understood that the structure of the three coal feed tubes shown in FIG. 2 are substantially similar. Accordingly, discussion will be limited to the coal feed tube 20 near the bottom of the gasification chamber 18.

An interior portion 36 of the coal feed tube 20 can substantially match the shape of the exterior of the coal feed tube 20, or can be different, such as with a square coal feed tube having a substantially circular interior portion. The interior portion 36 of the coal feed tube 20 can define a hollow center extending partially or completely through the coal feed tube 20. An opening 21 can be provided at one end of the coal feed tube 20. Accordingly, the interior portion 36 can allow coal to pass through the opening 21 and into the gasification chamber 18. The interior portion 36 can include one or more helical flights 35. The helical flights 35 may be formed from a single flight extending circularly along the interior portion 36. Conversely, the helical flights 35 may include a plurality of flights extending along the interior portion 36. As will be described below, the coal feed tube 20 can be stationary, such that the helical flights 35 can rotate and slide coal in the coal feed tube 20 towards the gasification chamber 18. In one example, a rotatable auger or screw feeder could be provided with each coal feed tube 20 such that the auger or screw feeder could rotate to drive the coal in the coal feed tube 20 towards the gasification chamber 18.

The coal feed tube 20 can extend from the exterior to the interior of the gasification chamber 18 and can be attached to the wall 14 of the gasification chamber 18. In the shown example, the coal feed tube 20 can be attached to the wall by a flange 34 and a plurality of screws, bolts, or the like (not shown). However, other possible attachment means are envisioned, such as a male-female threading attachment, a snap fit attachment, etc. The wall 14 may include one or more threaded holes (not shown) for receiving the plurality of screws from the flange 34. Consequently, the coal feed tube 20 can be attached to the wall 14 such that a portion of the coal feed tube 20 extends into the gasification chamber 18 while another portion of the coal feed tube 20 is located outside of the gasification chamber 18.

The coal feed tube 20 can include a coal inlet 30 allowing for the delivery of coal into the coal feed tube 20. The coal inlet 30 can include a hole 28 extending through the coal feed tube 20 such that coal can pass through the coal inlet 30 into the interior portion 36. The hole 28 can be positioned at a variety of locations along the length of the coal feed tube 20, and is not limited to the shown example. For instance, the coal inlet 30 could be positioned closer to the wall 14 or at an end of the coal feed tube 20. Further, the coal inlet 30 can include a coal feeding device 32 configured to deliver coal through the hole 28. The coal feeding device 32 can include a number of structures. For instance, in the shown example, the coal feeding device 32 includes a cylindrically shaped hopper, however, a variety of other coal delivering devices are envisioned. The cylindrically shaped hopper can receive coal from a separate device or structure (not shown) and deliver a controlled amount of coal through the hole 28.

The coal feeding device 32 can include a valve 31 to selectively allow and prevent the passage of coal. The valve 31 could include a variety of control devices that allow and prevent coal to pass, such as stoppers, or the like. In one example, the valve 31 could include a double valve, such that one valve could be sealed while another valve could be opened. In this example, the double valve could define an intermediate chamber positioned between the two valves, such that the middle chamber can hold coal while one of the valves is sealed, thus maintaining the temperature and pressure within the coal feed tube 20. Accordingly, coal can be provided to the coal feeding device 32 while the valve 31 maintains a seal with the coal feed tube 20 at all times.

The coal feed tube 20 can further include a condensation inlet 38. The condensation inlet 38 can deliver steam and/or water to the interior portion 36 of the coal feed tube 20. The condensation inlet 38 can be positioned anywhere along the length of the coal feed tube 20 outside of the gasification chamber 18. The condensation inlet 38 can include a hole formed in the coal feed tube 20 allowing for water and/or steam to pass through the hole into the interior portion 36 of the coal feed tube 20. A hose, tube, pipe, or the like (not shown) can be operatively attached to the condensation inlet 38 and can deliver steam and/or water through the condensation inlet 38.

The operation of the coal feed tube 20 can now be described. Coal can be delivered from an external source to the coal inlet 30. Coal can be inserted into the coal feeding device 32 and pass through the hole 28 into the interior portion 36 of the coal feed tube 20. The coal feed tube 20 can be rotated, such that the helical flights 35 drive the coal along the interior portion 36 towards the gasification chamber 18. Simultaneously, steam and/or water may be provided from the condensation inlet 38.

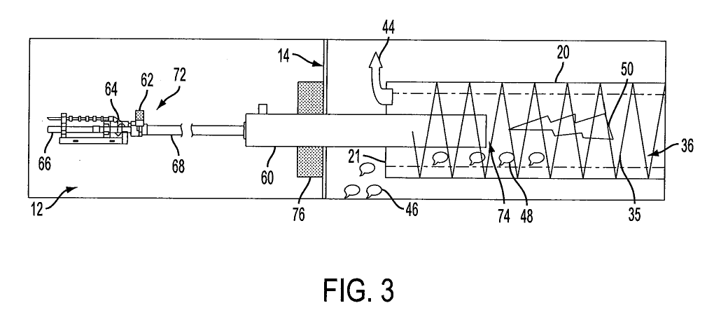

Referring now to FIG. 3, an example of the pulse detonation device 12 is shown in operative association with the gasification chamber 18 and the coal feed tube 20. The pulse detonation device 12 can include a fuel inlet 64 in operative association with a pulse detonation chamber 60. The fuel inlet 64 can deliver fuel to the pulse detonation chamber 60 such that the delivered fuel and air mixture will be detonated in the pulse detonation chamber 60. It is to be understood that the term ‘fuel’ can encompass a variety of different fuels. The fuel inlet 64 can deliver a variety of fuels to the pulse detonation chamber 60 including either a liquid fuel or a non-liquid fuel, such as a gas. Furthermore, the fuel inlet 64 can deliver ethylene, propane, methane, hydrogen, or the like. The fuel inlet 64 can be operatively attached to a fuel supply source. The fuel inlet 64 can include a tube, pipe, conduit, or any other suitable tubing for delivering the fuel from the fuel supply source to the pulse detonation chamber 60.

The pulse detonation device 12 can further include an air inlet 66 in operative association with the pulse detonation chamber 60. The air inlet 66 can deliver air or compressed air to the pulse detonation chamber 60. The air can include pure oxygen, an oxygen combination, atmospheric air, or any number of air and oxygen mixtures,. The air inlet 66 can be operatively attached to an air supply source, such as an air compressor, that provides pressurized air to the air inlet 66. Similar to the fuel inlet 64, the air inlet 66 can include a tube, pipe, conduit, or any other suitable tubing for delivering air.

The fuel inlet 64 and air inlet 66 can deliver fuel and air, respectively, from an external source to the pulse detonation chamber 60. The fuel and air can mix in the pulse detonation chamber 60, or at a location before reaching the pulse detonation chamber 60. For instance, a pulse detonator 68 is included from the fuel inlet 64 and air inlet 66 to the pulse detonation chamber 60. The pulse detonation chamber 60 can further include an ignition device 62. The ignition device 62 can be positioned at the fuel and air inlet end 72 of the pulse detonator 68. The ignition device 62 can include a number of structures known in the art, such as a spark plug, spark discharge, heat source, or the like. The ignition device 62 can be connected to a controller in order to operate the ignition device 62 at desired times.

Referring still to FIG. 3, the pulse detonation chamber 60 is shown in attachment with the wall 14 of the gasification chamber 18. The pulse detonation chamber 60 can receive the fuel and air mixture to create a shock wave. The pulse detonation chamber 60 can be an elongated tube with a hollow center and/or with obstacles inside. The pulse detonation chamber 60 can extend from the inlet end 72 to an outlet end 74. The outlet end 74 can define an opening in the pulse detonation chamber, such that the hollow center with or without obstacles defines a combustion chamber with an open end, the outlet end 74. The pulse detonation chamber 60 can be of any length, and is not limited to the length in the shown example. Moreover, the pulse detonation chamber 60 can include a variety of shapes, such as a circular shape, oval shape, square shape, etc. The pulse detonation chamber 60 can be attached to the wall 14 of the gasification chamber 18 such that the pulse detonation chamber 60 can extend from the exterior, through the hole 16, and to the interior of the gasification chamber 18. In the shown example, the pulse detonation chamber 60 can be attached to the wall by a flange 76 and a plurality of screws, bolts, or the like (not shown). However, other possible attachment means are envisioned, such as a male-female threading attachment, a snap fit attachment, etc. The wall 14 may further include one or more threaded holes (not shown) for receive the plurality of screws from the flange 34.

The pulse detonation chamber 60 can be aligned with the opening 21 of the coal feed tube 20. As such, the pulse detonation chamber 60 can extend at least partially through the opening 21 of the coal feed tube 20 and into the interior portion 36 of the coal feed tube 20. The outer diameter of the pulse detonation chamber 60 can be slightly smaller than the inner diameter of the interior portion 36, such that at least some space is available between the outer diameter of the pulse detonation chamber 60 and the inner diameter of the interior portion 36. In a further example, the pulse detonation chamber 60 could be formed as a common structure with the coal feed tube 20. In such an example, the pulse detonation chamber 60 could be attached to the interior of the coal feed tube 20 or formed at least partially integrally with the coal feed tube 20.

The operation of the pulse detonation device 12 in operative association with the coal feed tube 20 can now be described. The combustion of the fuel and air mixture by the ignition device 62 can produce a shock wave 50 that propagates through the pulse detonation chamber 60, exits the outlet end 74, and enters the coal feed tube 20, whereupon the shock wave 50 reacts with coal 48 in the coal feed tube 20. To create the shock wave 50, the fuel and air can be supplied through the fuel inlet 64 and the air inlet 66, respectively. As discussed, the fuel and air can mix either prior to entering the pulse detonation chamber 60, or upon entering the pulse detonation chamber 60 at the inlet end 72. As more fuel and air are introduced and mixed in the pulse detonation chamber 60, the pulse detonation chamber 60 can fill with the fuel/air mixture, starting at the inlet end 72 and progressing towards the outlet end 74. A controller (not shown) can track the amount of fuel/air mixture in the tube and can close the valve and stop the flow of the fuel and/or air from the fuel inlet 64 and air inlet 66.

The ignition device 62 can be triggered by a controller to initiate the combustion of the fuel/air mixture by providing a spark to the pulse detonation chamber 60. The spark can create a flame within the fuel/air mixture near the ignition device 62. The flame can consume the fuel/air mixture by burning it and, as such, the flame will propagate through the fuel/air mixture within the pulse detonation chamber 60 towards the outlet end 74. The flame propagating through the pulse detonation chamber 60 creates an extremely high temperature and pressure environment to produce a detonation wave, or a shock wave 50. Pressure can increase behind the shock wave 50 to drive the shock wave 50 towards the outlet end 74. The shock wave 50 travels down the length of the pulse detonation chamber 60 and out of the outlet end 74. Upon leaving the pulse detonation chamber 60, the shock wave 50 can be traveling at extremely high speeds, such as from Mach 2 to Mach 5, and at 1500 ft/sec. Similarly, the pressure immediately generated by the shock wave 50 can also be extremely high, such as 18 to 30 times the initial pressure. For instance, if the shock wave is traveling through an atmospheric pressure vessel, the pressure front of the shock wave could be 14 times atmospheric pressure. The temperature of the shock wave 50 can also be extremely high and can include a high temperature reaction zone. Depending on the specific application and the fuel/air mixture, the flame temperature of the high temperature reaction zone can range from 2,000 Kelvin to 3,000 Kelvin.

Upon exiting the outlet end 74 of the pulse detonation chamber 60, the shock wave 50 can enter the interior portion 36 and interact with any coal 48 in the coal feed tube 20. The shock wave 50 can provide a localized high temperature and high pressure, and low oxidization environment to the coal 48 within the coal feed tube 20. The high pressure generated by the shock wave 50 can be in the range of 19 bars. At this temperature and pressure, the coal 48 can be converted primarily to a gas mixture 44 of carbon monoxide (CO), methane (CH₄), and hydrogen (H₂). The shock wave 50 can travel partially or completely along the length of the coal feed tube 20. The helical flights 35 can allow the shock wave 50 to travel along the coal feed tube 20 by not obstructing the path of the shock wave 50. Also, the helical flights 35 can reduce the speed of travel of the shock wave 50 such that the shock wave 50 produces a localized high pressure and temperature to a specific area. As such, the shock wave 50 will produce a high pressure and high temperature environment along a length of the coal feed tube 20, such that improved gasification is not limited to the immediate vicinity of the outlet end 74.

This chain reaction can happen as the pulse detonation device cycles. The pulse detonation device cycles can vary from several cycles to almost continuous based on the arrangement of multiple pulse detonators 68 around the pulse detonation chamber 60. Accordingly, the arrangement of multiple pulse detonation chambers can deliver multiple and continuous shock waves in a continuous manner to the gasification chamber 18. As such, it is to be understood that the detonation process can be cyclical with a sequence of bursts or detonations creating a plurality of shock waves. The gas mixture 44 can exit towards the top of the opening 21 provided at the end of the coal feed tube 20. Similarly, the reaction also produces coal ash which is converted to slag 46. The slag 46 can also exit towards the bottom of the opening 21 at the end of the coal feed tube 20. Accordingly, the slag 46 can fall towards the bottom of the gasification chamber 18 and be discharged through the discharge outlet 24. Similarly, the gas mixture 44 can rise towards the top of the gasification chamber 18 and be discharged through the gas outlet 26.

It is to be understood by one of ordinary skill in the art that the pulse detonation device 12 is not limited to the shown example. Pulse detonation devices are known in the art and any number of pulse detonation devices with varying structures and/or operating parameters could be used in the present example. Similarly, the number of pulse detonation devices are not limited to the shown examples of FIGS. 1 and 2. Accordingly, more or fewer of the pulse detonation devices 12 can be used. Moreover, the pulse detonation devices 12 can be provided at a variety of different angles and locations with respect to the gasification chamber 18. Even further, the pulse detonation devices 12 may extend into the gasification chamber 18, but not into the coal feed tubes 20. In such an example, each of the pulse detonation devices 12 could produce one or more shock waves 50 that interact with coal within the gasification chamber 18.

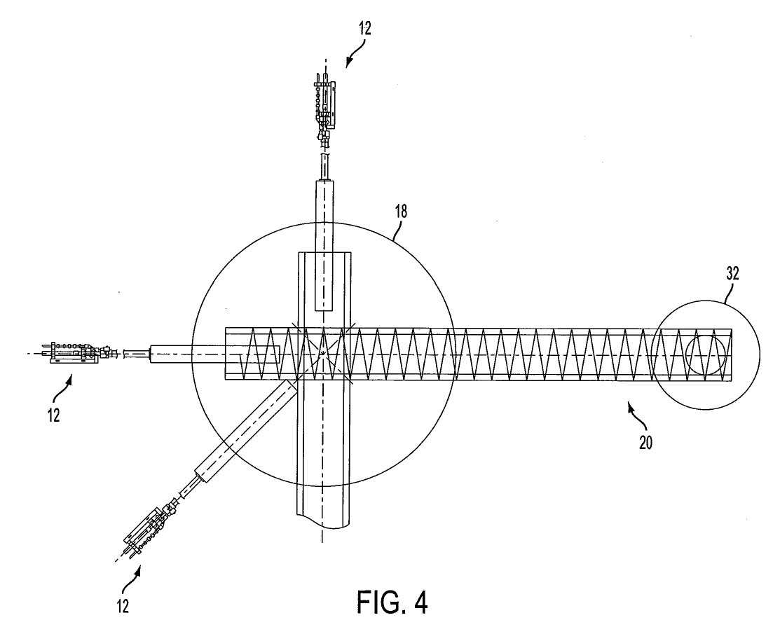

Referring now to FIG. 4, a top cutaway view of an example of the gasification chamber 18 is shown. It is to be understood that the pulse detonation devices 12 can be positioned at various heights throughout the gasification chamber 18, as shown in FIGS. 1 and 2. Similarly, as shown in the example of FIG. 4, the pulse detonation devices 12 can be positioned at various angles around the gasification chamber 18. For instance, the pulse detonation devices 12 are not limited to a vertical linear configuration, and can be positioned around the gasification chamber 18, such as at 7 o'clock, 9 o'clock and 12 o'clock locations. Accordingly, the coal feed tubes 20 can be positioned at opposing sides on the gasification chamber 18 opposite of the pulse detonation devices 12. As such, the pulse detonation devices 12 and coal feed tubes 20 can be positioned at various heights along the gasification chamber 18 and at various angles around the gasification chamber 18.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A pulse detonation device providing a shock wave for promoting a coal gasification reaction in a gasification device, the pulse detonation device including:
a fuel inlet configured to receive fuel;
an air inlet configured to receive air;
a pulse detonation chamber wherein the fuel and air are configured to mix; and
an ignition device configured to ignite the mixture of fuel and air, wherein the ignition of the mixture of fuel and air creates a shock wave in the pulse detonation chamber;
wherein the pulse detonation chamber is attached to a gasification chamber and is configured to extend into the gasification chamber, further wherein the shock wave is configured to exit the pulse detonation chamber and interact with coal in the gasification chamber.

2. The pulse detonation device of claim 1, wherein the pulse detonation chamber includes an elongated section having an open end.

3. The pulse detonation device of claim 2, wherein the open end of the pulse detonation chamber is configured to be positioned within a coal feed tube that extends into the gasification chamber, further wherein the shock wave is configured to exit the pulse detonation chamber and interact with coal in the coal feed tube.

4. The pulse detonation device of claim 3, wherein the open end extends at least partially into the coal feed tube such that the shock wave exits the open end and enters the coal feed tube.

5. The pulse detonation device of claim 1, wherein the shock wave exiting the pulse detonation chamber and interacting with the coal travels at a velocity between Mach 2 to Mach 5.

6. The pulse detonation device of claim 1, wherein the shock wave exiting the pulse detonation chamber and interacting with the coal ranges in pressure between 18 to 30 times the initial pressure.

7. The pulse detonation device of claim 1, wherein the shock wave exiting the pulse detonation chamber and interacting with the coal includes a high temperature reaction zone.

8. The pulse detonation device of claim 1, wherein the interaction of the shock wave and the coal is configured to react with the coal and produce a gas mixture including carbon monoxide (CO), methane (CH₄), and hydrogen (H₂).

9. A gasification system for promoting a coal gasification reaction in a gasification device, the gasification system including:
a gasification chamber;
at least one coal feed tube including an inlet configured to receive coal, wherein the at least one coal feed tube extends from an exterior of the gasification chamber to an interior of the gasification chamber; and
at least one pulse detonation device, the at least one pulse detonation device including a pulse detonation chamber in which fuel and air are configured to mix and ignite, wherein the ignition of the mixture of fuel and air is configured to produce a shock wave exiting from an end of the pulse detonation chamber;
wherein the pulse detonation chamber of the at least one pulse detonation device is configured to extend from the exterior of the gasification chamber, through a wall of the gasification chamber, and into an interior of the at least one coal feed tube, further wherein the shock wave is configured to exit the pulse detonation chamber and interact with coal in the at least one coal feed tube.

10. The gasification system of claim 9, wherein the shock wave exiting the pulse detonation chamber and interacting with the coal travels at a velocity between Mach 2 to Mach 5.

11. The gasification system of claim 9, wherein the shock wave exiting the pulse detonation chamber and interacting with the coal ranges in pressure between 18 to 30 times the initial pressure.

12. The gasification system of claim 9, wherein the at least one pulse detonation device includes a plurality of pulse detonation devices, further wherein the plurality of pulse detonation devices are configured to deliver multiple shock waves in a continuous manner to the gasification chamber.

13. The gasification system of claim 9, wherein the pulse detonation chamber includes an open end, further wherein the open end is configured to be positioned within the at least one coal feed tube.

14. The gasification system of claim 13, wherein the open end extends at least partially into the at least one coal feed tube such that the shock wave exits the open end and enters the at least one coal feed tube.

15. The gasification system of claim 9, wherein the at least one coal feed tube includes an interior portion, further wherein the interior portion includes one or more helical flights.

16. The gasification system of claim 15, wherein the one or more helical flights is configured to rotate, such that the one or more helical flights rotate and are configured to move the coal from the at least one coal feed tube into the gasification chamber.

17. The gasification system of claim 9, wherein the interaction of the shock wave and the coal in the at least one coal feed tube is configured to react the coal and produce a gas mixture including carbon monoxide (CO), methane (CH₄), and hydrogen (H₂).

18. The gasification system of claim 17, wherein the gasification chamber includes a gas outlet, further wherein the gas mixture is configured to exit the at least one coal feed tube and exit the gasification chamber through the gas outlet.

19. A method of providing a shock wave to increase gasification within a gasification device, the method including:
providing a pulse detonation device having an open end;
attaching the pulse detonation device to the gasification chamber, wherein the open end of the pulse detonation device extends at least partially into the gasification chamber;
mixing fuel and air in the pulse detonation device; and
igniting the mixture of fuel and air in the pulse detonation device to create a shock wave, wherein the shock wave exits the open end of the pulse detonation device, enters the gasification chamber, and interacts with coal in the gasification chamber.

20. The method of claim 19, further including the step of:
providing a coal feed tube extending from an exterior of a gasification chamber to an interior of the gasification chamber, wherein the coal feed tube is configured to provide coal from an interior portion of the coal feed tube and into the gasification chamber;
positioning the open end of the pulse detonation device into the coal feed tube, wherein the shock wave exits the open end of the pulse detonation device, enters the coal feed tube, and interacts with coal in the coal feed tube.
